(19) United States
(12) Patent Application Publication
(10) Pub. No.: US 2007/0004352 A1
(43) Pub. Date: Jan. 4, 2007

(54) Device, system and method of wireless signal detection

(76) Inventor: Shai Waxman, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/170,107

(22) Filed: Jun. 30, 2005

(51) Int. Cl. H04B 1/00; H04Q 7/20; H04B 17/02

(52) U.S. Cl. 455/134; 455/132

(57) ABSTRACT

Briefly, some embodiments of the invention provide devices, systems and methods of wireless signal detection. For example, an apparatus in accordance with an embodiment of the invention may include a multi-receiver configuration including a plurality of wireless receivers; an activation controller to selectively activate a first number of said receivers in a detection mode to search for a wireless signal, and to selectively activate a second number of said wireless receivers in a reception mode to receive said wireless signal, and a detector to detect said wireless signal based on at least one extended detection portion of at least one data packet carried by said wireless signal.

### BACKGROUND OF THE INVENTION

In the field of wireless communications, a first wireless communication station may include multiple transceivers able to communicate, for example, with a second wireless communication station or a wireless access point., e.g., to increase throughput.

Unfortunately, the power consumption of existing multi-transceiver communication devices, for example, multi-transceiver devices operating in accordance with Institute of Electrical and Electronics Engineers (IEEE) 802.11n standard, is generally much higher than the power consumption of single-transceiver devices.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system including a wireless station able to selectively activate-one or more receivers of a multi-receiver, in accordance with an embodiment of the invention; and

FIG. 2 is a schematic flow-chart of a method of selectively activating one or more receivers of a multi-receiver, in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with many apparatuses and systems, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a wireless network, a Local Area Network (LAN), a Wireless LAN (WLAN), devices and/or networks operating in accordance with existing IEEE 802.11, 802.11a, 802.11b, 802.11e, 802.11g, 802.11 h, 802.11i, 802.11n, 802.16 standards and/or future versions of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. It is noted that embodiments of the invention may be used in various other apparatuses, devices, systems and/or networks.

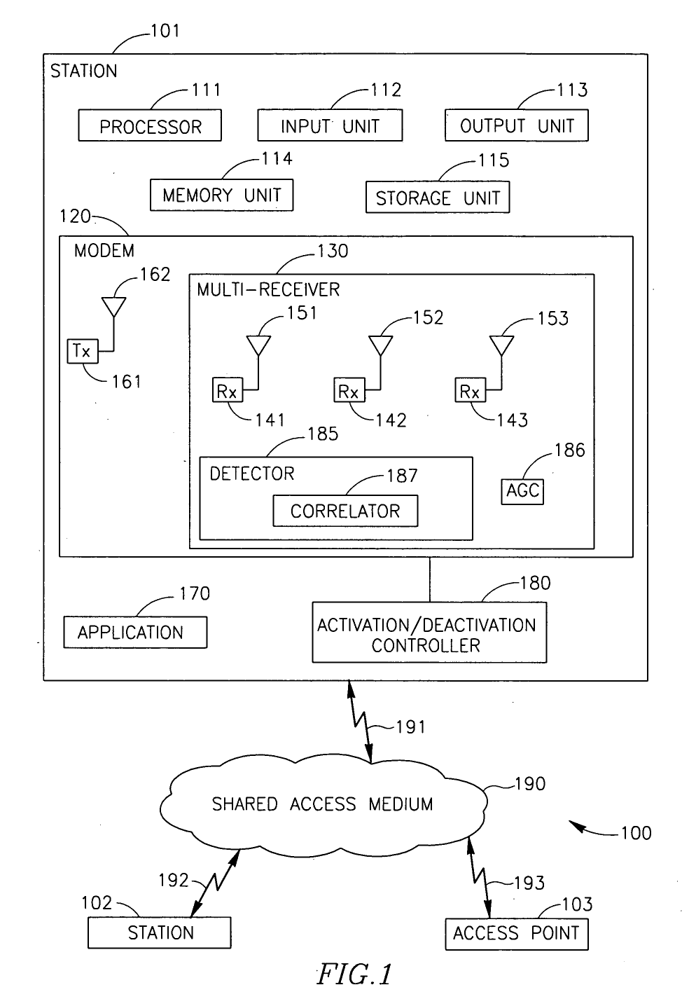

FIG. 1 schematically illustrates a block diagram of a wireless communication wireless communication system including a wireless communication station able to selectively activate one or more receivers of a multi-receiver in accordance with an embodiment of the invention. System 100 may include one or more wireless communication stations, e.g., stations 101 and 102, and one or more wireless access points, e.g., access point 103. Station 101, station 102 and access point 103 may communicate using a shared access medium 190, for example, through wireless communication links 191, 192 and 193, respectively.

Station 101 may include, for example, a processor 111, an input unit 112, an output unit 113, a memory unit 114, a storage unit 115, and a modem 120. Station 101 may further include other hardware components and/or software components.

Processor III may include, for example, a Central Processing Unit (CPU), a Digital Signal Processor (DSP), a microprocessor, a controller, a chip, a microchip, an Integrated Circuit (IC), or any other suitable multi-purpose or specific processor or controller.

Input unit 112 may include, for example, a keyboard, a keypad, a mouse, a touch-pad, a microphone, or other suitable pointing device or input device. Output unit 113 may include, for example, a Cathode Ray Tube (CRT) monitor or display unit, a Liquid Crystal Display (LCD) monitor or display unit, a speaker, or other suitable monitor or display unit or output device.

Memory unit 114 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Storage unit 115 may include, for example, a hard disk drive, a floppy disk drive, a Compact Disk (CD) drive, a CD-ROM drive, or other suitable removable or non-removable storage units.

Modem 120 may include, for example, a wireless modem having, for example, a wireless transmitter 161 and a wireless multi-receiver configuration 130. Transmitter 161 may include, for example, a Radio Frequency (RF) transmitter able to transmit RF signals, e.g., through an antenna 162. Multi-receiver 130 may include multiple receivers, for example, receivers 141, 142 and 143, able to receive RF signals, e.g., via multiple antennas, for example, antennas 151, 152 and 153, respectively.

In some embodiments, the functionality of transmitter 161 and multi-receiver 130 may be implemented in the form of a multi-transceiver, a transceiver, a transmitter-receiver, or one or more units able to perform separate or integrated functions of sending and/or receiving wireless communication signals, blocks, frames, transmission streams, packets, messages and/or data.

Antenna 162, antenna 151, antenna 152 and/or antenna 153 may include an internal and/or external RF antenna, for example, a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data.

In some embodiments, optionally, an application 170 may be executed by one or more components of station 101, for example, by processor 111. The application 170 may include, for example, a software application, an Operating System (OS), a communications driver, or the like, and may be stored in memory unit 114 and/or storage unit 115.

In some embodiments, station 101 may further include an activation/deactivation controller 180 to selectively activate and/or deactivate one or more of receivers 141-143, e.g., in a detection mode and/or in a reception mode. The activation/deactivation controller 180 may be implemented as, for example, a sub-unit of station 101, a sub-unit of processor 111, a sub-unit of modem 120, a sub-unit of receiver 130, a controller, an activation controller, a selective activation controller, or other hardware component and/or software component.

In some embodiments, when station 101 searches for a wireless communication signal (“detection mode”), receiver 141 may be activated, whereas receivers 142-143 may be deactivated. For example, as long as a wireless signal is not detected by station 101, activation/deactivation controller 180 may selectively activate receiver 141 and may deactivate receivers 142-143. Accordingly, only one of receivers 141-143, namely, receiver 141, may search for wireless communication signals. This may, for example, reduce the power consumed by station 101 when it searches for a wireless communication signal.

Upon detection of a wireless communication signal, the activation/deactivation controller 180 may selectively activate one or more of receivers 142-143, e.g., to receive the detected signal (“reception mode”). In one embodiment, additional receiver(s) 142 and/or 143 may be activated if a signal is detected by receiver 143 and other conditions hold true, for example, if a Signal to Noise Ratio (SNR) of the detected signal is lower than a per-defined threshold. In another embodiment, in reception mode, receiver 141 may be deactivated, and receivers 142 and 143 may be activated to receive the signal. In yet another embodiment, for example, only one of receivers 141-143 may be selectively activated in detection mode, and two or more of receivers 141-143 may be selectively activated in reception mode, e.g., based on the SNR of the wireless signal. In some embodiments, other conditions or criteria may be used to selectively activate a first number of receivers 141-143 in detection mode, and a second, e.g., greater, number of receivers 141-143 in reception mode.

In some embodiments, receiver 141 may include, or may be operationally associated with, a detector 185 adapted or configured to detect wireless communication signals. Detector 185 may include, for example, a correlator 187 able to scan multiple channels for a pattern which may be repeated across multiple short-preamble cycles. Detector 185 may be implemented, for example, as part of multi-receiver 130, as part of one or more receivers 141-143, or as a separate unit of station 101.

A wireless communication signal may carry, for example, one or more data packets, e.g., Orthogonal Frequency-Division Multiplexing (OFDM) data packets. A data packet may include one or more portions, for example, a preamble portion and a data portion. The preamble portion may include, for example, a short preamble and a long preamble.

The short-preamble may include multiple, e.g., ten, short-preamble cycles, for example, in time intervals of approximately 0.8 microseconds. A conventional wireless communication station may use one or more, e.g., three or five, of the short-preamble cycles for signal detection; these short-preamble cycles may be referred to herein as “basic short-preamble cycles”. The conventional wireless communication station may use one or more, e.g., five or seven, of the short-preamble cycles for various other functions, e.g., to determine settings of an Automatic Gain Control (AGC) unit 186, to estimate timing and frequency shifts, or the like; these additional short-preamble cycles may be referred to herein as “extended short-preamble cycles”.

The long-preamble may include multiple long-preamble cycles, which may be used by the conventional wireless communication station for fine frequency estimation, channel estimation, and/or other non-detection functions.

The data portion may include data, e.g., audio data, video data, control data, or the like. In one embodiment, the data portion may include symbol repetition periodicity, for example, such that a symbol may be repeated in pre-defined intervals (“guard intervals”), e.g., of approximately 4 microseconds.

In accordance with some embodiments, detector 185 may detect a wireless communication signal based on one or more extended short-preamble cycles, one or more long-preamble cycles, and/or symbol repetition periodicity; these portions may be referred to herein as “extended detection portions”. For example, correlator 187 may scan one or more extended detection portions for a repeating pattern, and upon identifying such repeating pattern, detector 185 may determine that a wireless communication signal is detected.

In one embodiment, detector 185 may detect a wireless signal based on one or more extended detection portions and one or more basic short-preamble cycles. In another embodiment, detector 185 may detect a wireless signal based on one or more basic short-preamble cycles and one or more extended short-preamble cycles. In yet another embodiment, detector 185 may detect a wireless signal based on multiple extended short-preamble cycles. In still another embodiment, detector 185 may detect a wireless signal based on substantially all the basic short-preamble cycles and substantially all the extended short-preamble cycles. In a farther embodiment, detector 185 may detect a wireless signal based on short-preamble cycles of more than one short-preamble, e.g., 10 short-preamble cycles, 15 short-preamble cycles, 20 short-preamble cycles, or the like. In another embodiment, detector 185 may detect a wireless signal based on one or more basic short-preamble cycles, one or more extended short-preamble cycles, one or more long-preamble cycles, and/or symbol repetition periodicity of a data portion.

In one embodiment, for example, detector 185 may detect a wireless signal based on five basic short-preamble cycles and five extended short-preamble cycles. This may allow, for example, a signal detection sensitivity at least 3 dB higher than the signal detection sensitivity of a conventional station using up to five short-preamble cycles for signal detection.

In some embodiments, the detector 185 may detect a wireless communication signal, but may not necessarily immediately receive one or more data packets carried by the detected signal. For example, since only receiver 141 may be activated when station 101 searches for a signal, the activation/deactivation controller 180 may selectively activate one or more of receivers 142-143 such that station 101 may receive the detected signal.

In some embodiments, one or more extended short-preamble cycles, or other extended detection portions of a data packet, may be used by detector 185 for detection, and thus may not be available for other estimation or calculation operations, e.g., for determining or setting a parameter of the AGC unit 186. Therefore, in one embodiment, a parameter of the AGC unit 186 may be set or pre-set to a pre-defined value, e.g., the AGC unit 186 may be set to operate at its maximal power level.

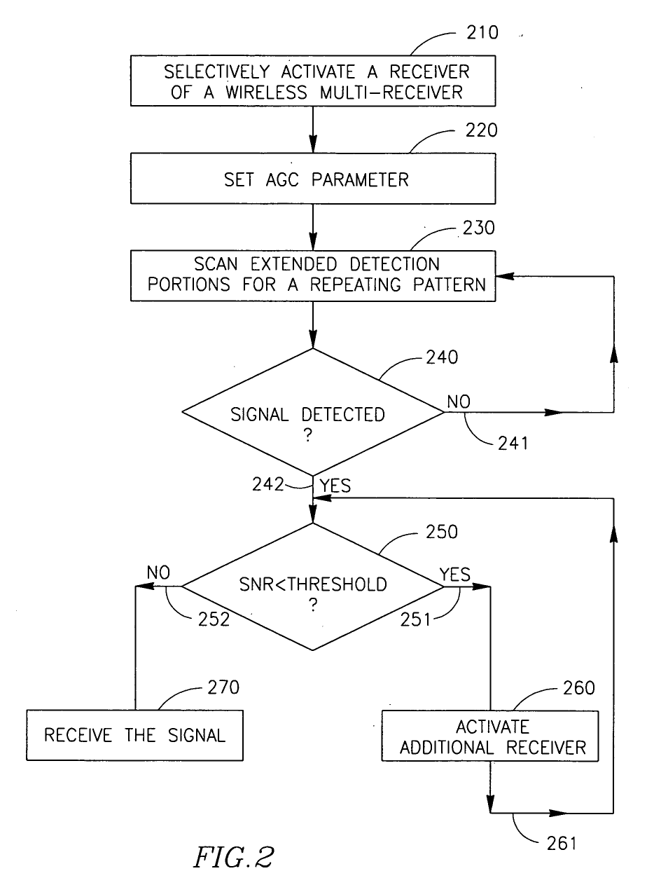

FIG. 2 is a schematic flow-chart of a method of selectively activating one or more receivers of a multi-receiver in accordance with an embodiment of the invention. Operations of the method may be implemented, for example, by system 100 of FIG. 1, by station 101 of FIG. 1, by station 102 of FIG. 1, by access point 103 of FIG. 1, by processor 11 of FIG. 1, by modem 120 of FIG. 1, by multi-receiver 130 of FIG. 1, by detector 185 of FIG. 1, by correlator 187 of FIG. 1, by activation/deactivation controller 180 of FIG. 1, and/or by other suitable stations, access points, controllers, modems, processors, units, devices, and/or systems.

As indicated at box 210, the method may optionally include, for example, selectively activating a receiver of a wireless multi-receiver. This may include, for example, selectively deactivating substantially all other receivers of the wireless multi-receiver.

As indicated at box 220, the method may optionally include, for example, setting a parameter of an AGC unit to a pre-defined value. For example, the AGC unit may be set to operate at its maximal power level.

As indicated at box 230, the method may optionally include, for example, scanning one or more extended detection portions of a data packet, e.g., for a repeating pattern. This may include, for example, performing auto-correlation using one or more extended short-preamble cycles, one or more long-preamble cycles, one or more data portions, e.g., possibly having symbol repetition periodicity, and/or, optionally, one or more basic short-preamble portions.

As indicated at box 240, the method may optionally include, for example, checking whether a signal, e.g., an OFDM signal, is detected.

As indicated by arrow 241, if the checking result is negative, then the method may include, for example, repeating the operations of boxes 220 and 230.

Conversely, as indicated by arrow 242, if the checking result is positive, then the method may include, for example, proceeding to the operations of box 250 and onward.

As indicated at box 250, the method may optionally include, for example, checking whether the SNR of the detected signal is lower than a pre-defined threshold.

As indicated by arrow 251, if the checking result is positive, then, as indicated at box 260 the method may include activating an additional receiver of the multi-receiver. Optionally, as indicated by arrow 261, the method may then include repeating the operations of box 250 and onward.

Conversely, as indicated by arrow 252, if the checking result is negative, then, as indicated at box 270, the method may include receiving the signal.

Other suitable operations or sets of operations may be used in accordance with embodiments of the invention. For example, in one embodiment, the method may include selectively activating a first number of receivers in a detection mode to search for a wireless signal, and selectively activating a second number of receivers in a reception mode to receive the wireless signal, wherein the first number is smaller than the total number of receivers, and wherein the second number is greater than the first number.

Although portions of the discussion herein may relate, for exemplary purposes, to selectively activating and/or deactivating of one or more receivers, embodiments of the invention are not limited in this regard, and may include, for example, modifying or setting an operational status, modifying or setting an operational parameter, turning on, turning off, bringing into or out of a stand-by mode, bringing into or out of a “sleep” mode, bringing into or out of a power-saving mode or a reduced power mode, or the like.

Although portions of the discussion herein may relate, for exemplary purposes, to selectively activating and/or deactivating of a receiver, embodiments of the invention are not limited in this regard, and may include, for example, activating or deactivating a chain of receivers, a receiver path, a receiver chain, or more than one receiver.

Some embodiments of the invention may be-implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or-controllers, or devices as are known in the art. Some embodiments of the invention may include buffers, registers stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by station 101 of FIG. 1, by station 102 of FIG. 1, by access point 103 of FIG. 1, by processor 111 of FIG. 1, by modem 120 of FIG. 1, by receiver 130 of FIG. 1, by activator/deactivator 180 of FIG. 1, by detector 185 of FIG. 1, by correlator 186 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 114 or storage unit 115), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a multi-receiver configuration including a plurality of wireless receivers;
an activation controller to selectively activate a first number of said receivers in a detection mode to search for a wireless signal, and to selectively activate a second number of said wireless receivers in a reception mode to receive said wireless signal; and
a detector to detect said wireless signal based on at least one extended detection portion of at least one data packet carried by said wireless signal.

2. The apparatus of claim 1, further comprising an Automatic Gain Control unit to determine gain, and wherein said detector is to set a parameter of said Automatic Gain Control unit to a pre-defined value.

3. The apparatus of claim 2, wherein said pre-defined value is a maximum power level of said Automatic Gain Control unit.

4. The apparatus of claim 1, wherein said at least one extended detection portion comprises at least one extended short-preamble cycle.

5. The apparatus of claim 1, wherein said at least one extended detection portion comprises at least one long-preamble cycle.

6. The apparatus of claim 1, wherein said at least one extended detection portion comprises a symbol repetition periodicity portion.

7. The apparatus of claim 1, wherein said detector comprises a correlator to search for a pattern repeated in said at least one extended detection portion.

8. The apparatus of claim 1, wherein said activation controller is to selectively activate said second number of wireless receivers in said reception mode if a Signal to Noise Ratio of said wireless signal is lower than a threshold.

9. The apparatus of claim 1, wherein said first number is smaller than the number of said plurality of receivers, and wherein said second number is greater than said first number.

10. A wireless communication device comprising:
the apparatus of claim 1; and
an antenna to receive said wireless signal.

11. A method comprising:
selectively activating a first number of wireless receivers of a multi-receiver configuration including plurality of wireless receivers in a detection mode to search for a wireless signal;
detecting said wireless signal based on at least one extended detection portion of at least one data packet carried by said wireless signal; and
selectively activating a second number of said wireless receivers in a reception mode to receive said wireless signal.

12. The method of claim 11, further comprising:
setting a parameter of an Automatic Gain Control unit to a pre-defined value.

13. The method of claim 12, wherein setting comprises:
setting the parameter of the Automatic Gain Control unit to a maximum power level.

14. The method of claim 11, further comprising:
detecting said wireless signal based on at least one extended detection portion of at least one data packet carried by said wireless signal.

15. The method of claim 11, wherein detecting comprises:
detecting said wireless signal based on at least one long-preamble cycle of at least one data packet carried by said signal.

16. The method of claim 11, wherein detecting comprises:
detecting said wireless signal based on a symbol repetition periodicity portion of at least one data packet carried by said wireless signal.

17. The method of claim 11, wherein detecting comprises:
searching for a pattern repeated in said at least one extended detection portion.

18. The method of claim 11, wherein selectively activating the second number of wireless receivers comprises:
selectively activating said second number of wireless receivers if a Signal to Noise Ratio of said wireless signal is lower than a threshold.

19. The method of claim 11, further comprising:
receiving said wireless signal.

20. A wireless communication system comprising:
a wireless communication station including at least:
a multi-receiver configuration including a plurality of wireless receivers;
an activation controller to selectively activate a first number of said receivers in a detection mode to search for a wireless signal, and to selectively activate a second number of said wireless receivers in a reception mode to receive said wireless signal; and
a detector to detect said wireless signal based on at least one extended detection portion of at least one data packet carried by said wireless signal.

21. The wireless communication system of claim 20, wherein said wireless communication station further comprises an Automatic Gain Control unit to determine gain, and wherein said detector is to set a parameter of said Automatic Gain Control unit to a pre-defined value.

22. The wireless communication system of claim 20, wherein said at least one extended detection portion comprises at least one extended short-preamble cycle.

23. The wireless communication system of claim 20, wherein said activation controller is to selectively activate said second number of wireless receivers in said reception mode if a Signal to Noise Ratio of said wireless signal is lower than a threshold.
